(19) United States
(12) Patent Application Publication
(10) Pub. No.: US 2002/0135615 A1
(43) Pub. Date: Sep. 26, 2002

(54) Overlaid display for electronic devices

(75) Inventor: Eric G. Lang, Redmond, WA (US)

Correspondence Address: Homer L. Knearl, Merchant & Gould P.C., P.O. Box 2903, Minneapolis, MN, 55402-0903, US

(73) Assignee: Microsoft Corporation

(21) Appl. No.: 09/773,971

(22) Filed: Jan. 31, 2001

(51) Int. Cl. G06F 3/00

(52) U.S. Cl. 345/764; 345/766

(57) ABSTRACT

An interface system and method for inputting control signals to an electronic device with a display and at least one input element. An application module is coupled with the input element and performs at least one task in response to the activation signal. The application module is additionally coupled to an information module and a control module. The information module receives at least one information image from the application module, and the control module receives at least one control image from the application module. Furthermore, the control image is associated with the input element. A rendering module coupled with the information module and the control module is used to create a compound image. The compound image created is a combination of the content image and control image such that the content image appears in front of the control image.

### TECHNICAL FIELD

The present invention relates to an interface for electronic devices, and more specifically to a graphical interface showing both an information screen and a control screen in an overlapping manner.

### BACKGROUND OF THE INVENTION

Small computing devices, such as personal digital assistants (PDAs) and smart watches, typically have a limited surface area on which to provide a display screen and user input elements. Because of this spatial constraint, input hardware, such as push buttons, knobs, and joysticks, are often assigned multiple functions in an effort to decrease the number of input elements needed on the device. For example, the same push button may be used to select menu options, enter data values, and maneuver a cursor during the device's operation. Generally, by assigning multiple functions to the input elements, the number of input elements on the device is decreased and more room is made available for a display screen.

One drawback of assigning multiple functions to input elements is that users may be required to remember how the functions of each input element change during the coarse of device operation. A solution to this is to devote a region of the display to remind the user what functions are currently assigned to input elements. Accordingly, the display may include, for example, a bottom line stating, “Press F2 to save, F3 to exit.” Devoting a region of the display to list input element assignments, however, decreases the amount of room available on the display for non-control information.

Another conventional method of increasing the display size of small electronic devices is to miniaturize the input hardware so that less surface area is taken up by input elements. Miniaturizing input hardware, however, reduces their handiness and often makes portable computing devices awkward to use.

Some portable computing devices utilize touch-sensitive displays for both outputting information and receiving user input. In such a configuration, the display is typically separated into an output region and a touch-sensitive input region. The output region of the display provides information to the user while the input region typically includes virtual input elements, such as radio buttons and slide-bars, for receiving user input. A touch-sensitive display also allows for virtual input elements to be added and removed according to the requirements of various device applications being executed.

Although conventional touch-sensitive displays may offer a more flexible input interface for smaller electronic devices, there still exists a tradeoff between the amount of display area devoted to outputting information to the user and the amount of display area devoted to receiving user input. For example, increasing the input area may facilitate input entry, but this also leaves less room on the display to output information. Thus, conventional user interface techniques may not provide a large enough area for both outputting information and receiving user input in small devices.

### SUMMARY OF THE INVENTION

In accordance with the present invention, the above and other problems are solved by combining informational images and input control images in a display such that both may occupy substantially the entire display area simultaneously. Thus, increasing the size of the input control images does not diminish the size of the informational images, and vise versa.

Briefly stated, the present invention involves a user interface for inputting control signals to an electronic device having a display and at least one input element. When implemented as a method, the method may include the acts of displaying an information screen in the display foreground and displaying at least one control image in the display background such that the control image appears behind the information screen. Moreover, the control image is associated with the input element and may indicate a task to be performed by the electronic device when the input element is activated. When the input element is activated, an activation signal is received and the activation of the input element is detected.

The invention may also be implemented as an article of manufacture such as a computer program product or computer readable media. The computer program product may be a computer storage media readable by a computer system and encoding a computer program of instructions for executing the above computer process. The computer program product may also be a propagated signal on a carrier readable by a computing system and encoding a computer program of instructions for executing the above computer process.

Another aspect of the present invention is an interface system for inputting control signals into an electronic device. When implemented as an interface system, the interface system includes at least one input element adapted to provide an activation signal when the input element is activated. An application module is also coupled with the input element and performs at least one task in response to the activation signal. The application module is additionally coupled to an information module and a control module. The information module receives at least one information image from the application module, and the control module receives at least one control image from the application module. Furthermore, the control image is associated with the input element. A rendering module coupled with the information module and the control module is used to create a compound image. The compound image created is a combination of the content image and control image such that the content image appears in front of the control image. The interface system also includes a display element coupled with the rendering module for displaying the compound image.

Yet another aspect of the present invention is a method for inputting characters to an electronic device. The electronic device includes a graphical user interface with a display and a plurality of input elements. The method includes a display operation for displaying an information screen in a display foreground. Another display operation for displaying a control screen in a display background, with the display background appearing behind the display foreground is also performed. A load operation for loading a character set is performed. The character set includes a plurality of individual characters. A divide operation for dividing the character set into character subsets is performed. The character subsets are represented in the control screen during a resenting operation. A receiving operation receives a selection signal for one of the character subsets. The range of the selectable character set is narrowed to the selected character subset during a narrowing operation. The dividing, representing, receiving, and narrowing operations are repeated until a selection of one of the individual characters is made.

These and various other features as well as advantages, which characterize the present invention, will be apparent from a reading of the following detailed description and a review of the associated drawings.

### BRIEF DESCRIPTION OF THE DRAWINGS

FIG. 1 shows an exemplary electronic device embodying the present invention.

FIG. 2 shows a simplified representation of a device architecture for implementing the present invention.

FIG. 3A shows a smart watch device embodying the present invention with exemplary information screen contents.

FIG. 3B shows a smart watch device embodying the present invention with exemplary control screen contents.

FIG. 3C shows a smart watch device embodying the present invention with exemplary composite screen contents.

FIG. 4 shows an operational flow diagram of the steps taken for inputting control signals to an electronic device as contemplated by the present invention.

FIG. 5 shows a system embodying the present invention.

FIG. 6 shows another system embodying the present invention.

FIG. 7 shows an exemplary control screen for another embodiment of the present invention.

FIG. 8 shows an exemplary control screen after a selection of a character subset is made from FIG. 7.

FIG. 9 shows an exemplary composite screen after a selection of a character subset is made from FIG. 8.

FIG. 10 shows an exemplary composite screen for another embodiment of the present invention.

FIG. 11 shows an operational flow diagram of the steps taken for inputting characters to an electronic device as contemplated by the present invention.

### DETAILED DESCRIPTION OF THE INVENTION

It is contemplated that the present invention is utilized in electronic devices with graphical user interfaces, and preferably in portable computer-based devices, such as a personal digital assistants (PDAs), smart watches, mobile telephones, and the like. The invention is described in detail below with reference to the figures. When referring to the figures, like structures and elements shown throughout are indicated with like reference numerals.

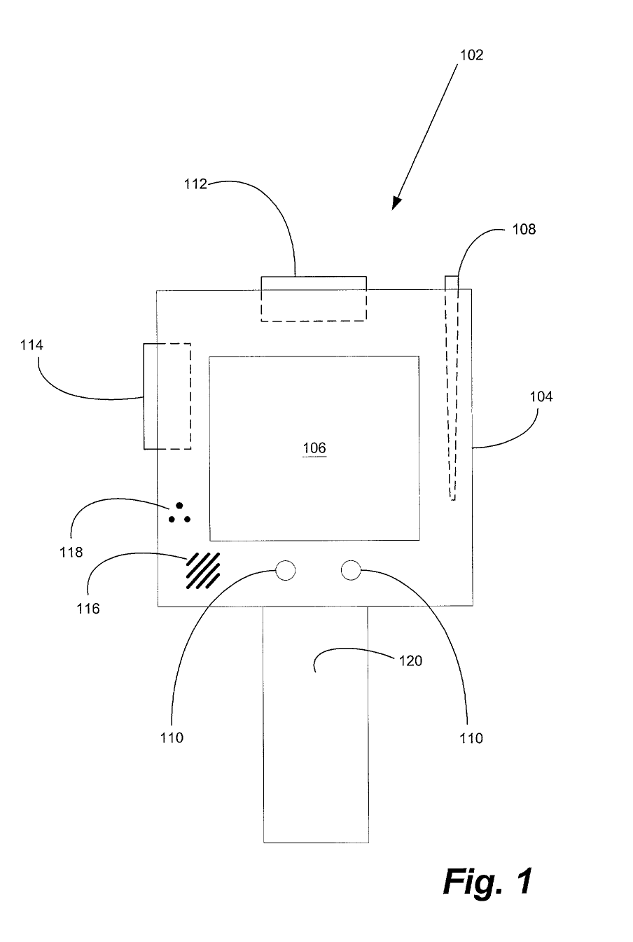

In FIG. 1, an exemplary electronic device 102 embodying the present invention is shown. The electronic device 102 includes a housing 104 containing the various components of the device 102. The housing 104 is made from a durable material, such as a metallic alloy or a hard plastic, capable of withstanding the rougher treatment associated with portable devices. The device 102 may also include a protective case or cover (not shown) to further prevent damage. Moreover, a strap 120 or belt clip (not shown) may be provided to hold the portable device 102 proximate the user.

The device 102 may include one or more input elements 110 mounted on the housing 104. The input elements 110 provide activation signals to the device 102 which are responsive to user interaction. Thus, the input elements allow a user to control the device 102 by selecting various tasks during different operating stages of the device 102. It is contemplated that several types of input elements 110 may be used in conjunction with the present invention. The input elements 110 used may include, but are not limited to, push button switches, rocker switches, joysticks, rotary dials, slide bars, and touch-sensitive displays.

The device 102 has a communication port 112 for communicating with other electrical devices. The communication port 112 may carry out wire based communications and/or wireless communications. Various communication protocols may be supported by the communication port 116, including Hyper Text Transfer Protocol (HTTP), Post Office Protocol (POP), Time Division Multiple Access (TDMA), Code Division Multiple Access (CDMA), and Wireless Application Protocol (WAP). It should be noted that the protocols listed above are provided as examples only; it is contemplated that many other protocols known by those skilled in the art may be supported by the smart watch 102. In one embodiment of the present invention, the smart watch 102 is part of a wireless piconet, such as a BLUETOOTH (TM) WAP. BLUETOOTH is a Trademark owned by Telefonaktiebolaget LM Ericsson.

An expansion slot 114 on the device 102 allows for other equipment to be coupled with the device 102. For example, an external storage media (not shown), such as a memory cartridge, magnetic disk drive, or optical disc drive may be coupled to the device 102 through the expansion slot 114. The expansion slot 114 may also be used to connect the device 102 to other peripherals, such as a printer, a scanner, and a digital camera (not shown).

The electronic device 102 includes a speaker 116 and a microphone 118. The speaker 116 can be used to play recorded music, provide auditory alarms, and produce other sound output. The microphone 118 can be used to detect sound for recording, pick-up voice commands, and carry out telephone communications.

A display 106 on the front face of the electronic device 102 is used to display informational images and control images in accordance with the present invention. The display 106 is preferably a liquid crystal display (LCD), however, other types of displays, such as a cathode ray tube (CRT), may be used. Furthermore, the display 106 may be a monochrome, gray scale, or color display. In one embodiment of the invention, the display 106 includes touch-sensitive input elements which provide activation signals to the device 102 when the display 106 is contacted by the user. A stylus 108 or other pointing device can be used in conjunction with a touch-sensitive display 106 to activate a small region of the touch-sensitive screen.

As discussed in greater detail below, the present invention blends an information screen and a control screen in an overlapping fashion such that both screens are displayed in the same display region simultaneously. The information and control screens are combined using graphical blending techniques such as alpha blending, simulated alpha blending, and XORing. By doing so, the amount of display space available to show information images is not dependent on the display area occupied by control images. Thus, the user interface of the present invention is capable of utilizing substantially all of the display area for both displaying information and receiving user input.

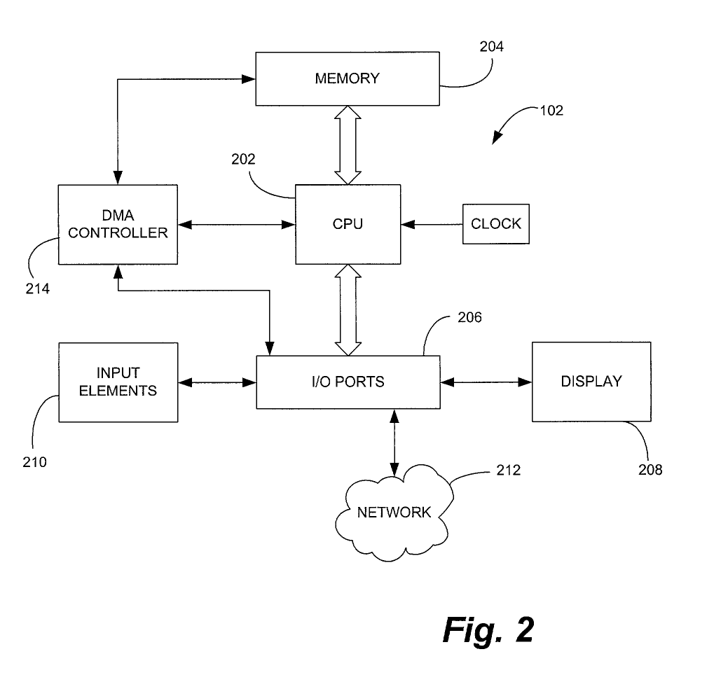

With reference now to FIG. 2, a simplified representation of the device architecture for implementing the present invention is shown. The electronic device 102 includes a central processing unit (CPU) 202 which is primarily responsible for carrying out arithmetic, logic, and control operations. The CPU 202 may include a floating point unit (FPU) and/or a co-processor (not shown) for accelerated graphics performance. Additionally, the CPU 202 may be a general purpose processor, a digital signal processor (DSP), or other state machine circuit.

A memory unit 204 for storage of data and program code is coupled with the CPU 202. The memory unit 204 may include a memory cache, random access memory (RAM), video RAM (VRAM), and read only memory (ROM). In addition, the memory unit 204 encompasses mass storage media, such as magnetic and optical memory media.

The CPU 202 also communicates with input/output (I/O) ports 206 which receive and transmit data from and to the outside environment. For example, the I/O ports 206 may connect the CPU 202 with a display 206, input elements 210, and a network 212. The CPU 202 may access the I/O ports 206 as either memory mapped I/O space or as separately mapped I/O space. In addition, the I/O ports 206 may also be configured to support interrupt driven CPU access.

The device 102 can include a dynamic memory access (DMA) controller 214 which enables the I/O ports 206 to read and write data from and to the memory unit 204 without involving the CPU 202. The DMA controller 214 is especially useful when bit-mapped images of the display 208 are stored in the memory unit 204. The DMA controller 214 allows the display 208 to quickly read the stored bit-mapped images without slowing down CPU performance.

According to one embodiment of the present invention, the memory unit 204 contains dedicated space for storing an information screen, a control screen, and a composite screen. As used herein, a “screen” is a digital representation of the display content. The amount of memory space required to store a screen is typically dependent on the display resolution and color depth of the screen. For example, a high resolution screen display generally requires more memory space to store images than a low resolution screen display. In one embodiment of the present invention, the control screen is of lower resolution and color depth than the information screen and the composite screen.

A computing device, such as electronic device 102, typically includes at least some form of computer-readable media. Computer readable media can be any available media that can be accessed by the electronic device 102. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

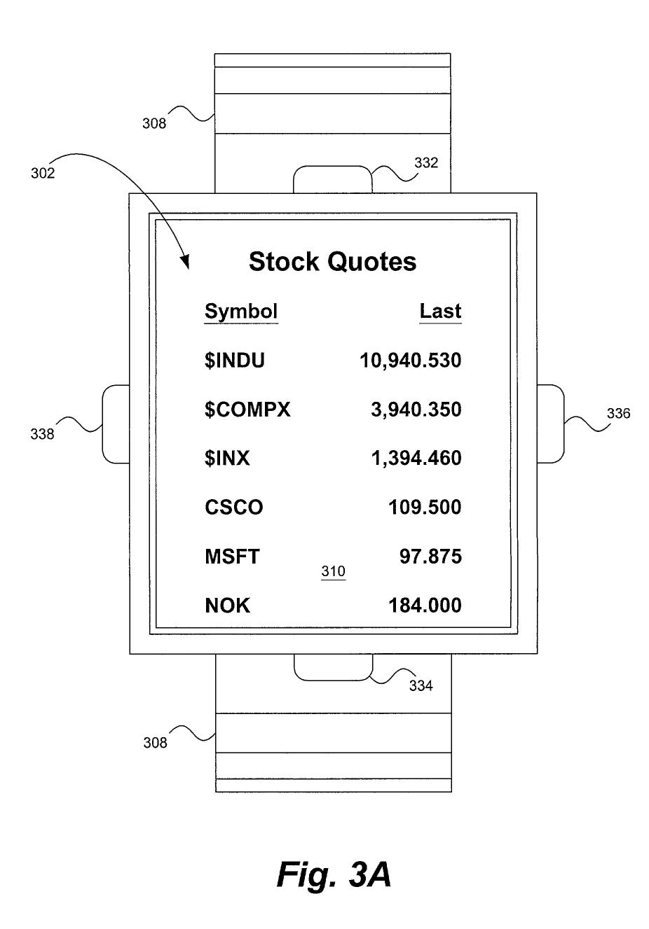

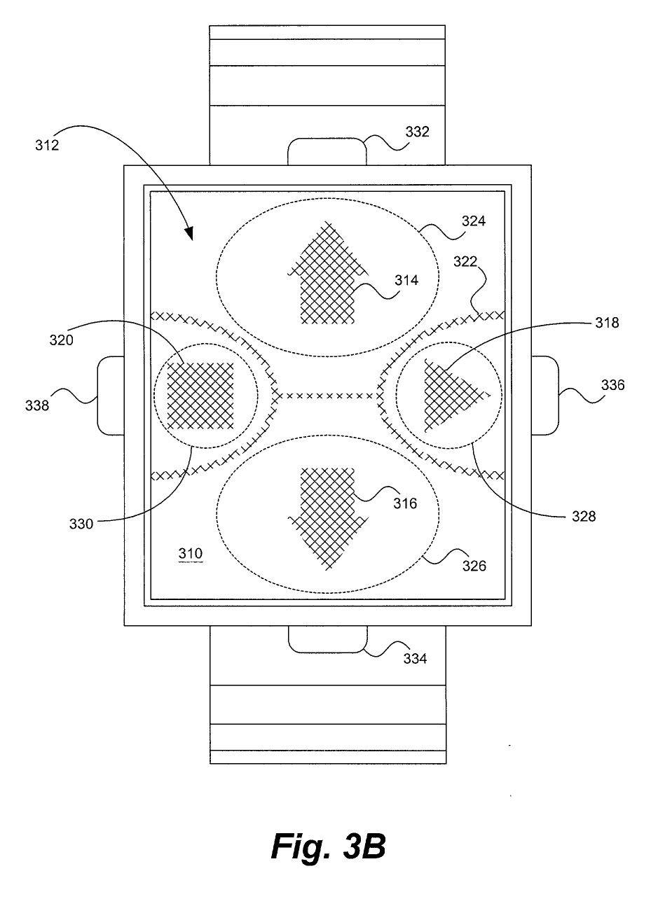

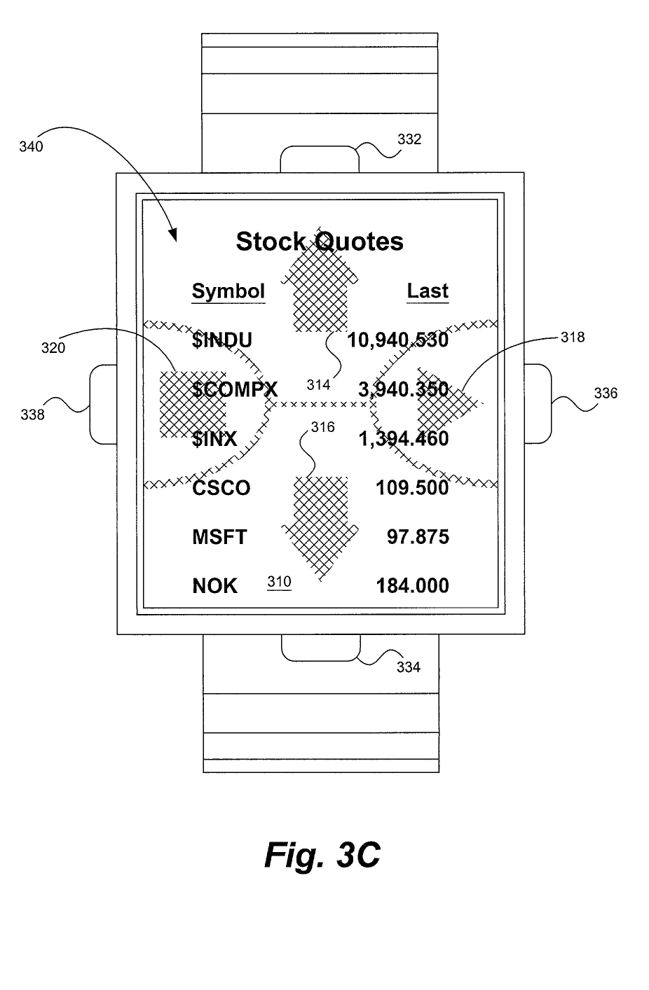

In FIG. 3A, exemplary information screen contents in a smart watch device 304 are shown. As introduced above, the smart watch 304 may include push buttons 332, 334, 336 and 338, a strap 308, and a display 310. The display 310 may or may not be a touch-sensitive display. Although the information screen 302 is shown providing investment data, generally any form of display output may be displayed in the information screen 302. Thus, the information screen 302 may include text images, graphics images, video images, or a combination thereof. As used herein, an “information image” refers collectively to the various informational objects contained in the information screen 302.

In FIG. 3B, the smart watch device 304 is shown with exemplary control screen contents, which are represented with crosshatched lines. The control screen 312 includes one or more control images 314, 316, 318, and 320 which, in general, convey symbolic representations of various tasks which the user can select. For example, control image 316 may indicate that the information screen will scroll down if an input element associated with the control image 316 is activated. Similarly, control image 318 may indicate execution of a scroll up task, and control images 320 and 322 may indicate execution of a play music task and a stop music task, respectively. It is contemplated that the control images used to indicate tasks are simple, low-resolution images with only a few colors. The control screen 312 may also contain dividing lines 322 and other images to help the user distinguish various regions 324, 326, 328, and 330 of the display.

In accordance with one embodiment of the present invention, control images 314, 316, 318, and 320 are associated with input elements. A control image is associated with an input element by positioning the control image in the display 310 proximate the input element. For example, control images 314, 316, 318, and 320 are associated with input elements 332, 334, 336 and 338, respectively. Thus, an in or down stroke of push button 332 causes the information screen 302 to scroll up. In another embodiment button 332 might have multiple strokes such as a stroke in each of four directions. In this embodiment only one button would be required to activate each of the four control images 314, 316, 318 and 320 as each control image would be associated with a stroke direction. If a touch-sensitive display is present, various display regions may be used as input elements. Thus, control images 314, 316, 318, and 320 may alternatively be associated with touch-sensitive display regions 324, 326, 328, and 330, respectively.

In FIG. 3C, the smart watch device 304 is shown with exemplary composite screen contents in the display 310. The composite screen 340 is a combined image of both the information screen 302 (shown in solid lines) and the control screen 312 (shown in cross hatched lines). Since the display 310 is utilized to present both the information screen 302 and the control screen 312 in the same physical location, a user interface with a relatively large input area may be achieved without compromising the amount of information presented to the user. Thus, large control images can be generated in the display 310 for easy user interaction. Additionally, the control images can be created, modified, or deleted according to the input requirements of the software being executed in the device 304.

Preferably, the information screen 302 and the control screen 312 are combined such that the information screen 302 appears to be in the display foreground and the control screen appears to be in the display background. Combining the information screen 302 and the control screen 312 in such an overlapping or watermark fashion may be achieved using software, hardware, or a combination of both. For example, the information screen 302 may be superimposed over one or more control images 314, 316, 318, and 320 using alpha blending, simulated alpha blending, or XORing techniques.

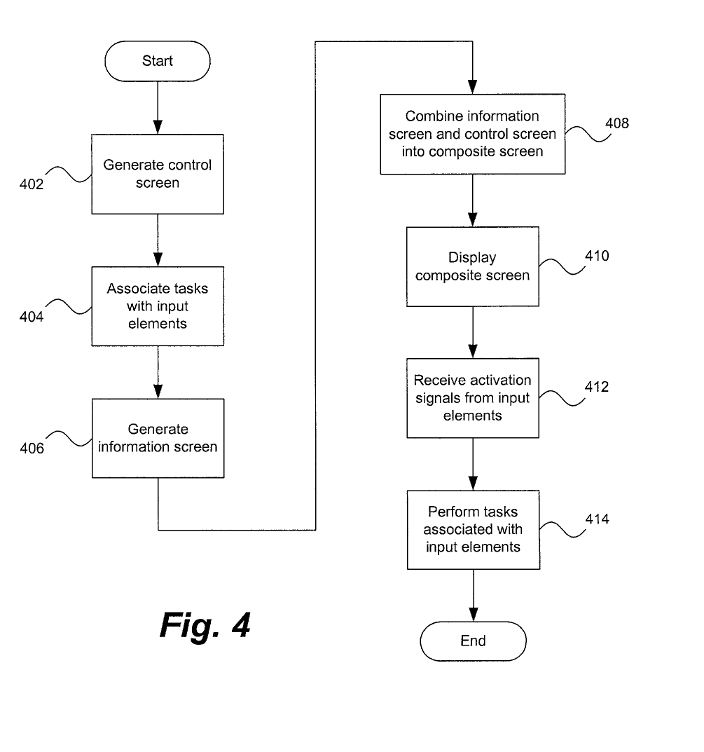

In FIG. 4, an operational flow diagram of the acts taken for inputting control signals to an electronic device as contemplated by one embodiment of the present invention are shown. The logical operations of the various embodiments of the present invention are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

A control screen operation 402 generates one or more control images. As previously mentioned, it is contemplated that the control screen resides in the device memory 204 (see FIG. 2) and is bit-mapped to the display. In one embodiment of the invention, the control screen is generated and modified by an application program displaying information in the display. If more than one application makes use of the display, then each application may access and modify the control screen according to the display area taken up by that application. As described below, the control screen can be generated and modified through an operating environment of the electronic device 102 or an application program interface (API).

When the control screen is generated, control images are associated with input elements by virtue of their position on the display. Thus, placing a control image next to an input element associates the control image with the input element. If a touch-sensitive display is used, associating the control image is accomplished by checking whether a touch coordinate returned by the touch-sensitive display falls within the display area occupied by the control image.

Associate operation 404 assigns input elements to tasks. As used herein, tasks refer to program code that is executed when an input element is activated. A task may include a single instruction code, a series of instruction codes, or an entire program. A task may be associated with an input element by executing or branching to the task when an activation signal is received from the input element. Alternatively, the task may be executed as part of an interrupt service routine initiated when an activation signal from the input element is received.

An information screen operation 406 generates the text images, graphical images and video images. The information screen, like the control screen, may be stored in the device memory 204 (see FIG. 2) and bit-mapped to the display. As mentioned previously, the information screen can contain such elements as text images, graphical images, and video images.

Composite screen operation 408 combines the information screen and the control screen to build a composite screen. This operation may utilize known image manipulation techniques such as alpha blending, simulated alpha blending, and XORing. For example, a transparency mask or “alpha channel” may be specified for both the information screen and the control screen. Pixel values in each screen are then multiplied by their respective alpha channel values. The information screen and the control screen are then overlaid by adding corresponding pixel locations in each screen, with the result stored in the composite screen. By adjusting alpha channel values, one screen may be brought forward while the other screen can appear to fall to the background. Preferably, the information screen and the control screen are blended such that the control screen appears behind the information screen in an overlapping or watermark fashion. However in an alternative embodiment, the control screen might be in the foreground and overlay an information screen in the background. The composite screen may be generated or built by dedicated hardware in the electronic device or by software executed in the CPU 202 (see FIG. 2). The composite screen may also be stored in reserved memory.

Display operation 410 displays the composite screen is displayed in the display 106 (FIG. 1). In one embodiment of the present invention, a display driver continuously updates the display screen by accessing the device memory and activating display pixels according to composite screen data. Furthermore, access to the composite screen may be carried out through the DMA controller 214 (see FIG. 2).

Activation signals from one or more input elements are received and detected by detect operation 412. The activation signals may be digital or analog in form, depending on the input element used. If a touch-sensitive display is used, the activation signal may include information corresponding to a contact location sensed by the display.

Perform operation 414 executes the tasks associated with the input elements according to received activation signals by detect operation 412. Typically, which task is executed, as well as when the task is executed, is controlled by the application running in the electronic device. It is contemplated that some tasks are “hard wired” to the activation signal and are automatically executed by the device irrespective of the application.

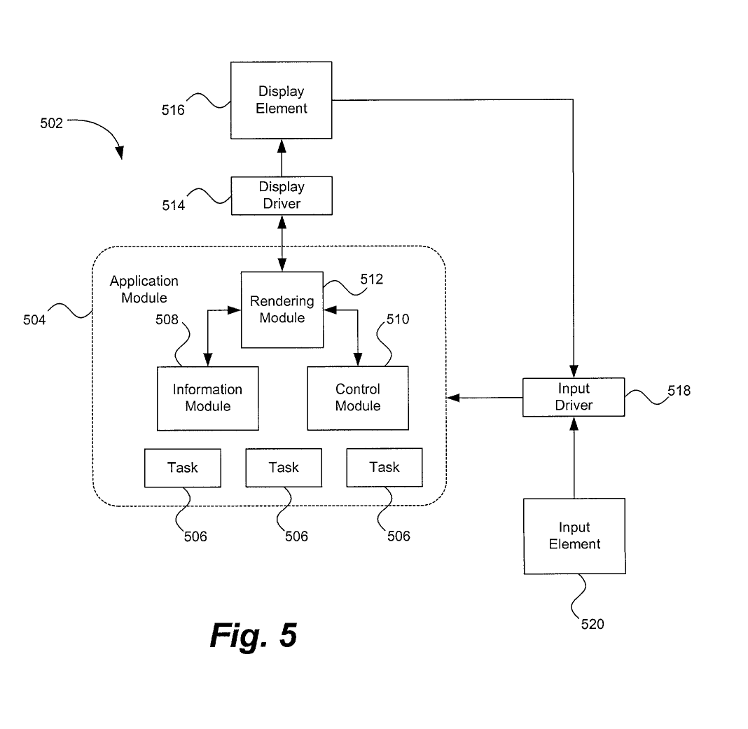

In FIG. 5, one embodiment of a system 502 embodying the present invention is shown. An application module 504 in the system 502 includes several tasks 506 which may be selectively executed according to the user's actions. The application module 504 also includes an information module 508 and a control module 510.

The information module 508 is generally responsible for generating and maintaining the information screen memory space. For example, the information module 508 may create, modify, or delete information images such as text images, graphic images, or other display images in the information screen memory space as needed by the application module 504. Thus, the application module 504 provides at least one information image to information module 508 for display in the information screen.

The control module 510 is responsible for generating and maintaining control images in the control screen memory space. In addition, the control module 510 may manage the location of control images such that the control images are associated with desired input elements. Thus, the application module 504 provides at least one control image to control module 510 for display in the control screen. In a system utilizing a touch-sensitive display, the control module 510 may return control image coordinates to the application 504 so that an associated input element can be located when an activation signal from the display is received.

A rendering module 512 in the application module 504 combines the information screen data and the control screen data to create a composite screen. As part of the process for generating the composite screen, the rendering module may scale the information screen and control screen data to fit the display dimensions of the device. As discussed above, the rendering module 512 may utilize known image manipulation techniques such as alpha blending, simulated alpha blending, and XORing.

A display driver 514 is coupled with the rendering module 510 and provides display data to a display 516. The display driver 514 may include built-in system software, such as basic input/output system (BIOS) code. Generally, the display driver formats data in the composite screen memory space into video signals which the display 516 then converts to light energy.

The application module 504 is coupled with an input driver 518. The input driver 518 receives activation signals from input elements 520, including a touch-sensitive display 516, and notifies the application 504 of their occurrence. The input driver 518 may include an interrupt controller which manages multiple interrupt signals sent to the application 504. When the input driver 518 notifies the application module 504 of a received activation signal from one or more input elements 520, the tasks 506 associated with the input elements are performed.

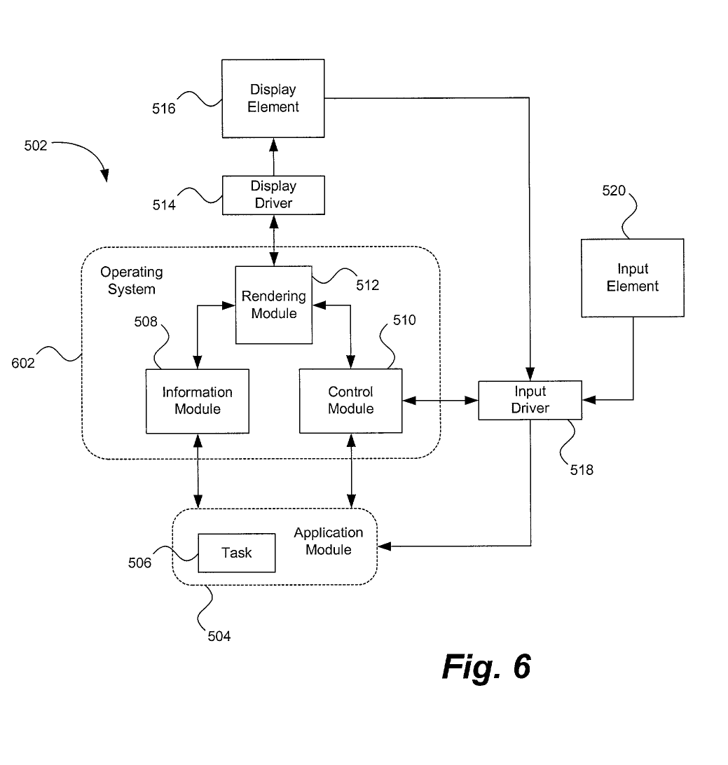

In FIG. 6, another embodiment of the present invention is shown wherein an operating system 602 includes the information module 508, the control module 510, and the rendering module 512. It is contemplated that the information module 508, the control module 510, and the rendering module 512 may exist in the operating system 602 as application interface programs (APIs) called by various applications. The operating system is configured to receive information screen data and control screen data from the application module 504. In this manner, the application module 504 merely generates information and control objects need not be concerned about generating a composite screen.

The input driver 518 may communicate directly with the application driver 518, as previously discussed, or may notify the control module 510 of received activation signals from input elements 520. If the control module 510 is notified of activation signals, the operating system 602 can determine the control object associated with the activated input element and provide the application module such information. In such a configuration, control objects are created through the operating system and the operating system notifies the application when a control object is activated.

In one embodiment of the present invention, the control screen 312 provides a user interface for inputting characters as described in U.S. Patent Application XX,XXX,XXX, titled “J-Key Inspection”, U.S. patent application Ser. No. 09/652,330, and incorporated in its entirety herein by reference. As detailed below, this embodiment provides a character set which is divided into several smaller character subsets. The user selects a character subset containing a desired character and the selected character subset is then divided into further subsets until the desired character is narrowed down and selected by the user. In a particular embodiment of the present invention the character set utilized is an English alphanumeric character set, however, it contemplated that other character sets may be used in the present invention.

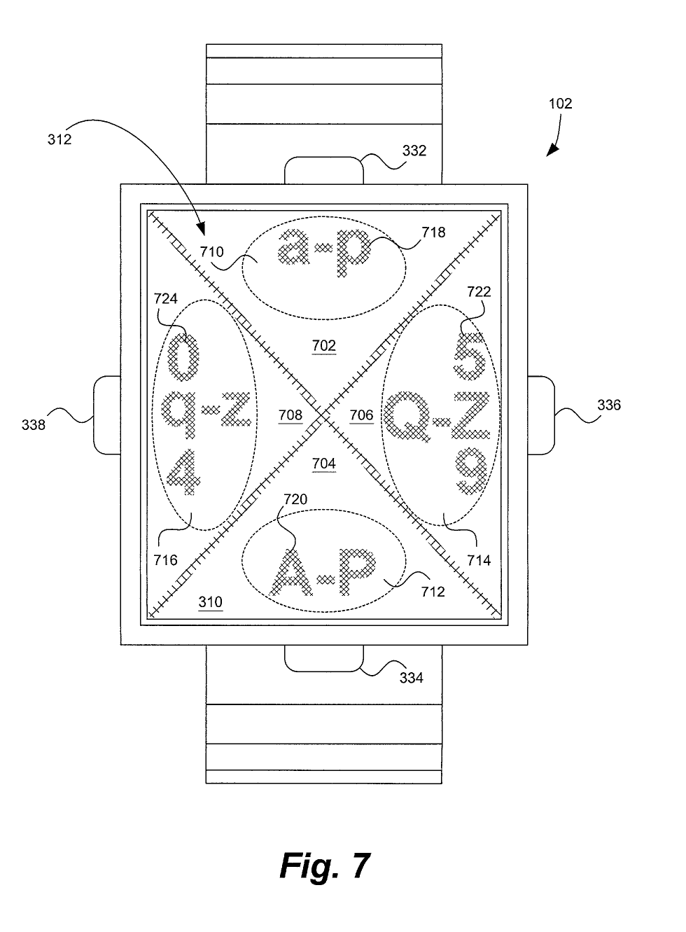

In FIG. 7, an exemplary control screen 312 embodying the present invention is shown divided into four quadrants 702, 704, 706, and 708. Each quadrant is associated with an input element. For example, the top quadrant 702 may be associated with a top touch-sensitive region 710 on the display. Likewise, the bottom quadrant 704 may be associated with a bottom touch-sensitive region 712, the right quadrant 706 may be associated with a right touch-sensitive region 714, and the left quadrant 708 may be associated with a left touch-sensitive region 716. In addition, quadrants 702, 704, 706, and 708 may be associated with pushbutton elements 332, 334, 336, and 338 respectively.

Each display quadrant 702, 704, 706, and 708 contains control images 718, 720, 722, and 724 representing a character subset. For example, control image 718 represents a character subset ranging from “a” to “p”. Furthermore, control image 722 represents a character subset ranging from “q” to “z” and “0” to “4”. As shown in Table 1, each smaller and smaller subset is presented to the user on the display 310 until the desired character is input by the user.

TABLE 1
Exemplary character subsets
abcdefghijklmnop
qrstuvwxyz01234
ABCDEFGHIJKLMNOP
QRSTUVWXYZ56789

| abcd | | | | ABCD | | | | qrst | | | | QRST | | | |
|---|---|---|---|---|---|---|---|---|---|---|---|---|---|---|---|
| efgh | | | | EFGH | | | | uvwx | | | | UVWX | | | |
| ijkl | | | | IJKL | | | | yz01 | | | | YZ56 | | | |
| mnop | | | | MNOP | | | | 234 | | | | 789 | | | |
| a | e | i | m | A | E | I | M | q | u | y | 2 | Q | U | Y | 7 |
| b | f | j | n | B | F | J | N | r | v | z | 3 | R | V | Z | 8 |
| c | g | k | o | C | G | K | O | s | w | 0 | 4 | S | W | 5 | 9 |
| d | h | 1 | p | D | H | L | P | t | x | 1 | | T | X | 6 | |

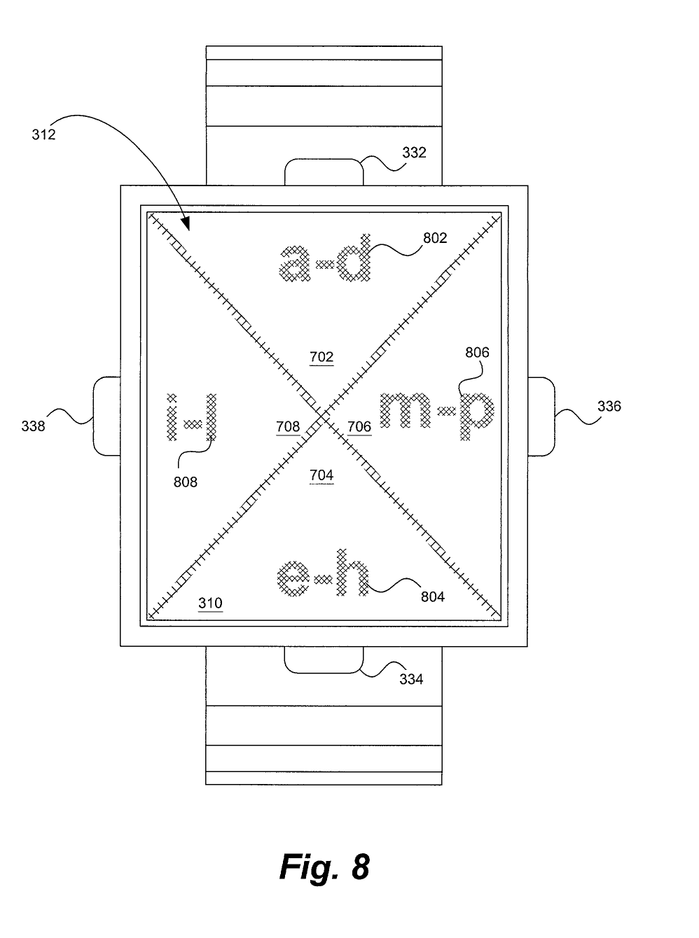

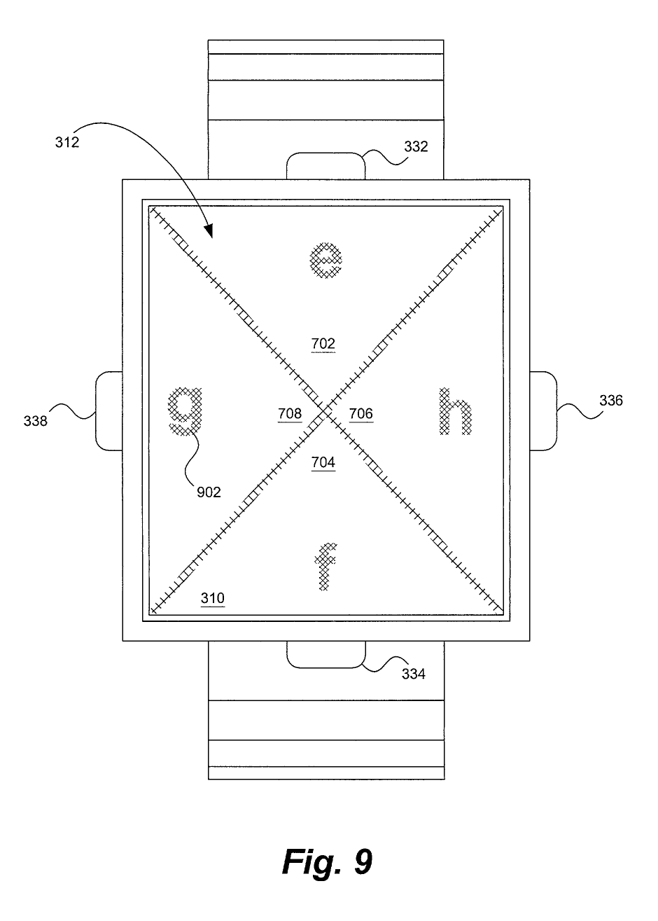

For instance, if a user desires to enter the letter “g” into the device 102, the top control image 718 is first selected which contains the letter “g” within the range of “a” to “p”. As shown in FIG. 8, the range of characters represented by the top control image 718 is divided into further character subsets in each quadrant 702, 704, 706, and 708. Thus, the top quadrant 702 includes a control image 802 representing a character subset ranging from “a” to “d”. Since the desired letter “g” is contained in the character range from “e” to “h”, as represented by bottom control image 804, the user then selects the bottom quadrant 704 by activating the associated input element. Once selected, the character subset from “e” to “h” is then broken down into individual characters, as shown in FIG. 9. The user therefore selects the left quadrant 708, which contains the control image 902 for the letter “g”.

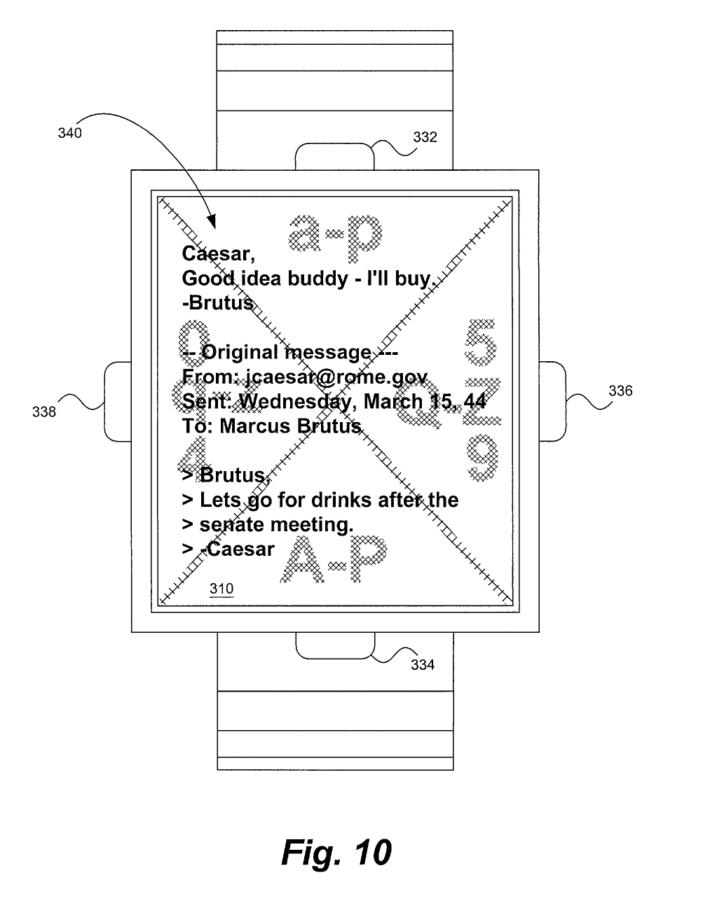

The iterative process described above allows users to enter characters and other data from a large range of possible values quickly and easily. As shown in FIG. 10, the characters entered by the user may be added to the information screen 302 and displayed in the foreground of the composite screen 340.

It is contemplated that the procedure described above may be used in combination with pushbuttons, command gestures, and voice commands. For example, a pushbutton may be used to switch character sets, such as switching from uppercase characters to lowercase characters. A pushbutton can also be used to input one or more frequently used characters, such a character space or a carriage return. Similarly, command gestures may also be used to select common characters. For example, movement of a user's finger from left to right across the touch-sensitive display 310 may indicate a character space, and movement in a clockwise direction across the touch-sensitive display 310 may indicate a carriage return.

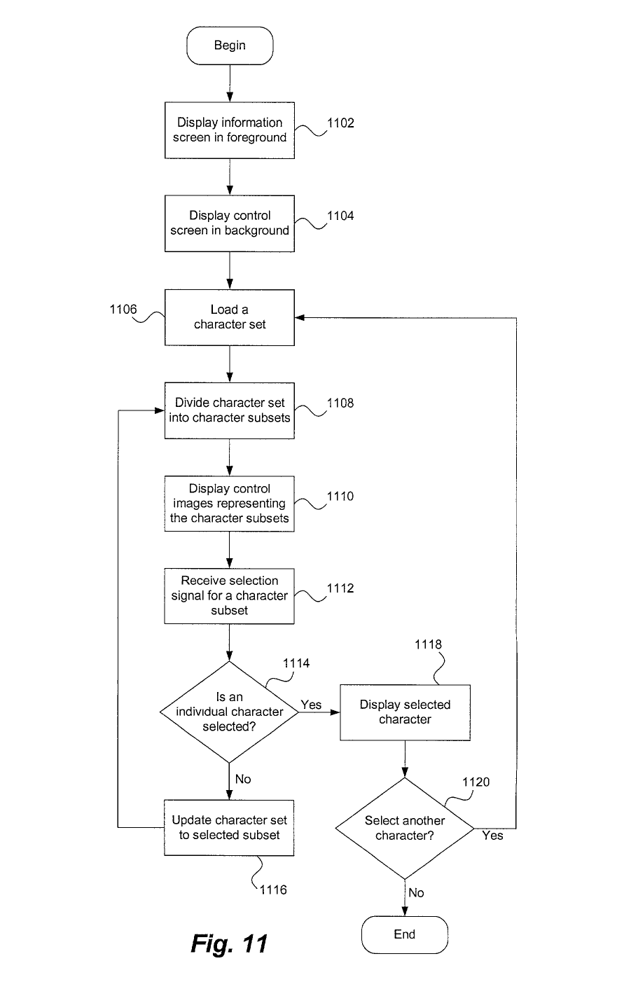

FIG. 11 illustrates an operation flow for entering text by a user, as described above. When an application is ready to receive character input from the user, the operation flow of FIG. 11 begins at display information screen operation 1102. The display information screen operation 1102 presents the information contained in the information module 508 at the foreground of the composite screen 340. Operation flow then proceeds to display control screen operation 1104.

In control screen operation 1104, the control screen 312 is displayed in the background of the composite screen 340. As previously discussed, the control screen 312 and the information screen 302 may be combined using alpha blending, simulated alpha blending, and XORing techniques. Furthermore, it is contemplated that the invention may be configured such that the control screen 312 is displayed in the foreground while the information screen 302 is displayed in the background.

Next, in loading operation 1106, a character set is accessed by the computing device 102. It is contemplated that the character set is stored in computer memory 204 and is loaded when needed. The character set may include all possible individual characters selectable by the user. For example, the character set may include uppercase letters, lowercase letters, numeric characters, and punctuation characters. The character set may further include special characters such as a carriage return, a tab, and a delete character. It is also contemplated that more than one character set may be stored in and selected from memory 204. Operation flow then proceeds to dividing operation 1108.

In dividing operation 1108, the character set is split into character subsets, wherein each subset contains a portion of the character set. The number of character subsets created is dependent on the number of input elements (i.e., touch-sensitive regions) provided for character selection. For example, if three input elements are available for character selection, three character subsets are created. Preferably, the character set is divided evenly, or as close to evenly as possible, between the character subsets.

Next, in display control images operation 1110, a control image (such as 718) representing a character subset is displayed in the control screen. In one embodiment of the present invention, the control images are located and retrieved from memory 204. Each control image is positioned in the control screen 312 such that it is associated with a particular input element. Control is then passed to receiving operation 1112.

In receiving operation 1112, a selection signal from an input element is detected by the computing device 102. The character subset associated with the input element is then examined at query operation 1114. If the character subset selected by the selection signal contains more than one character, control is passed to updating operation 1116.

In updating operation 1116, the character set is replaced with the selected character set of operation 1112. Control then passes to the dividing operation 1108 where the selected character subset is divided into smaller character subsets until the user selects a single character at query operation 1114. Once a single character is selected at query operation 1114, control is transferred to display operation 1118.

In display operation 1118, the selected character is displayed in the information screen 302. Next, at query operation 1120, the computer device 102 determines if another character is to be selected. If an additional character is required, control returns to loading operation 1106, where the operations are repeated. If no more characters are needed, the operation flow is completed and control returns to the application program.

Although the invention has been described and illustrated with a certain degree of particularity, it is understood that the present disclosure has been made only by way of example, and that numerous changes, combinations, and arrangements of techniques can be resorted to by those skilled in the art without departing from the spirit and scope of the invention as claimed below.

1. A method for providing a user interface for an smart watch device, the smart watch device having a graphical user interface including a display and at least one input element, the method comprising:
displaying an information screen in a display foreground;
displaying at least one control image in a display background, the display background appearing behind the display foreground, the control image indicating a task to be performed by the electronic device when the input element is activated; and
associating the control image with the input element.

2. The method of claim 1, further comprising receiving an activation signal from the input element.

3. The method of claim 2, further comprising performing the task associated with the input element after the activation signal is received.

4. The method of claim 1, wherein the act of associating further comprises positioning the virtual control image proximate the input element.

5. A user interface for an electronic device having a display and at least one input element, the user interface comprising:
displaying control images and information images in a same display area in overlaid fashion, the control images being associated with an input element; and
receiving an activation signal from the input element indicating a stroke of the input element and thereby activation of a control represented by the control image.

6. The user interface of claim 5 wherein each input element has multiple strokes and each control image is associated with one of the multiple strokes of the input element.

7. The user interface of claim 5 wherein the information image is overlaid on the control image so that the information image is in the foreground and the control image is in the background.

8. The user interface of claim 5 wherein the control image is overlaid on the information image so that the control image is in the foreground and the information image is in the background.

9. The user interface of claim 5 wherein each control image is associated with a control task to be executed after an activation signal is received.

10. A method for inputting control signals to an electronic device, the electronic device having a graphical user interface including a display and at least one input element, the method comprising:
generating an information screen;
generating a control screen having at least one control image;
associating the control image with the input element;
combining the information screen and the control screen into a composite screen such that the information screen and the control screen appear in an overlapping fashion; and
displaying the composite screen in the display.

11. The method of claim 10, wherein the associating operation includes positioning the control image proximate the input element.

12. The method of claim 10, wherein the combining operation includes blending the information screen and the control screen such that the information screen appears in front of the control screen.

13. The method of claim 10, wherein the generating the control screen operation includes indicating a task to be performed by the electronic device when the input element is activated.

14. The method of claim 10, wherein the combining operation includes blending the information screen and the control screen such that the control screen appears in front of the information screen.

15. The method of claim 10, further comprising the operation of receiving an activation signal from the input element.

16. The method of claim 15, further comprising the operation of performing the task associated with the input element after the activation signal is received.

17. An interface system for inputting control signals into an electronic device, the interface system comprising:
at least one input element adapted to provide an activation signal when the input element is activated;
an application module coupled with the input element, the application module performing at least one task in response to the activation signal;
an information module coupled with the application module, the information module receiving at least one information image from the application module;
a control module coupled with the application module, the control module receiving at least one control image from the application module, the control image being associated with the input element;
a rendering module coupled with the information module and the control module, the rendering module creating a display image, wherein the display image formats the content image and control image such that the content image appears in front of the control image; and
a display element coupled with the rendering module, the display element displaying the display image.

18. The interface system of claim 17, wherein the control module includes at least one control Application Programming Interface adapted to receive a plurality of control call parameters from the application module.

19. The interface system of claim 18, wherein the information module includes at least one content Application Programming Interface adapted to receive a plurality of content call parameters from the application module.

20. A computer program product readable by a computing system and encoding a computer program of instructions for executing a computer process for inputting control signals to an electronic device, the electronic device having a graphical user interface including a display and at least one input element, the computer process comprising:
generating an information screen;
generating a control screen having at least one control image;
associating the control image with the input element;
combining the information screen and the control screen into a composite screen such that the information screen and the control screen appear in an overlapping fashion; and
displaying the composite screen in the display.

21. The computer program product of claim 20, wherein the act of combining in the computer process comprises blending the information screen and the control screen such that the information screen appears in front of the control screen.

22. The computer program product of claim 20, wherein the act of generating the control screen in the computer process further comprises indicating a task to be performed by the electronic device when the input element is activated.

23. The computer program product of claim 20, wherein the act of combining in the computer process comprises blending the information screen and the control screen such that the control screen appears in front of the information screen.

24. The computer program product of claim 20 wherein the computer process further comprises receiving an activation signal from the input element.

25. The computer program product of claim 24 wherein the computer process further comprises performing the task associated with the input element after the activation signal is received.

26. A method for inputting characters to an electronic device, the electronic device having a graphical user interface including a display and a plurality of input elements, the method comprising:
displaying an information screen in a display foreground;
displaying a control screen in a display background, the display background appearing behind the display foreground;
loading a character set, the character set including a plurality of individual characters;
dividing the character set into character subsets;
representing the character subsets in the control screen;
receiving a selection signal for one of the character subsets;
narrowing the range of the selectable character set to the selected character subset; and
repeating the dividing, representing, receiving, and narrowing operations until a selection of one of the individual characters is made.

27. The method of claim 26, further comprising the operation of combining the information screen and the control screen into a composite screen such that the information screen and the control screen appear in an overlapping fashion.

28. The method of claim 26, wherein the representing operation includes the operation of providing control images for the character subsets.

29. The method of claim 28, further including the operation of associating the control images with the input elements.

30. The method of claim 29, wherein the associating operation includes positioning the control images proximate the input elements.

31. The method of claim 26, further including the operation of generating a selection signal from the input elements.

32. A computer program product readable by a computing system and encoding a computer program of instructions for executing a computer process for inputting control signals to an electronic device, the electronic device having a graphical user interface including a display and a plurality of input elements, the computer process comprising:
displaying an information screen in a display foreground;
displaying a control screen in a display background, the display background appearing behind the display foreground;
loading a character set, the character set including a plurality of individual characters;
dividing the character set into character subsets;
representing the character subsets in the control screen;
receiving a selection signal for one of the character subsets;
narrowing the range of the selectable character set to the selected character subset; and
repeating the dividing, representing, receiving, and narrowing operations until a selection of one of the individual characters is made.
